(19) United States
(12) Patent Application Publication
(10) Pub. No.: US 2018/0352625 A1
(43) Pub. Date: Dec. 6, 2018

(54) CONTROL CIRCUIT, LIGHTING APPARATUS, LUMINAIRE, SIGNBOARD, AND CONTROL METHOD FOR USE IN CONTROL CIRCUIT

(71) Applicant: Panasonic Intellectual Property Management Co., Ltd., Osaka (JP)

(72) Inventors: Keisuke SEKI, Osaka (JP); Shigeru IDO, Osaka (JP); Kazuhiko HAYASHI, Osaka (JP)

(21) Appl. No.: 15/984,385

(22) Filed: May 20, 2018

(30) Foreign Application Priority Data
May 30, 2017 (JP) 2017-106845

(51) Int. Cl. H05B 33/08; G09F 13/00

(52) U.S. Cl. CPC H05B 33/0848; G09F 13/04; G09F 13/005; H05B 33/0809

(57) ABSTRACT

Provided is a control circuit (modulation circuit) that receives output current determined based on a dimming signal, from a lighting device, consumes, as consumption current, part of the output current, and supplies supply current to a light-emitting element. The control circuit includes a regulator circuit that regulates the consumption current. The regulator circuit monotonously increases a magnitude of the consumption current relative to a magnitude of the output current.

### CROSS REFERENCE TO RELATED APPLICATION

This application claims the benefit of priority of Japanese Patent Application Number 2017-106845 filed on May 30, 2017, the entire content of which is hereby incorporated by reference.

### BACKGROUND

### 1. Technical Field

The present disclosure relates to a lighting device that supplies current to a light-emitting element such as a light-emitting diode (LED), a luminaire including the lighting device, a signboard including the lighting device, and a control method for use in the lighting device, and in particular to a lighting device etc. to which a modulation circuit for visible light communication is connected.

### 2. Description of the Related Art

In recent years, a lighting device including a modulation circuit for visible light communication has been proposed as a lighting device that supplies current to a light-emitting element such as an LED (e.g., see Patent Literature (PTL) 1 (Japanese Unexamined Patent Application Publication No. 2012-69505)). Such a lighting device allows a lighting apparatus to function as a data communication apparatus, and creates a convenient wireless environment.

In the lighting device of PTL 1, a series circuit of a resistor and a switch element is parallel added to a resistor connected in series with an LED. Accordingly, it is possible to easily add the circuit for visible light communication to the lighting device.

### SUMMARY

A technique for controlling a dimming level in a lighting device is known. The lighting device of PTL 1 is also capable of regulating current to be supplied to the LED so as to control a dimming level. For example, it is possible to control a dimming level of the lighting device based on a desired dimming curve indicating a relationship between a dimming signal externally inputted and a dimming ratio. It should be noted that here, a dimming ratio can be expressed by, for example, a current value of current flowing through an LED relative to the rated value of current that can be supplied to the LED.

In the lighting device of PTL 1, however, power for driving a modulation circuit is supplied from a constant current source that supplies current to the LED. For this reason, when the modulation circuit is connected to the lighting device, part of supply current from the constant current source to the LED determined based on a desired dimming curve flows through the modulation circuit. As a result, in the lighting device of PTL 1, when the modulation circuit is connected to the lighting device, a difference occurs between an actual dimming ratio and a dimming ratio indicated by the desired dimming curve.

The present disclosure has been conceived in view of the above problem, and has an object to provide: a control circuit that receives output current determined based on a dimming signal, supplies supply current to a light-emitting element, and is capable of bringing a dimming curve close to a desired dimming curve; a lighting apparatus, a luminaire, and a signboard each of which include the control circuit; and a control method for use in the control circuit.

In order to achieve the above object, a control circuit according to one aspect of the present disclosure is a control circuit that receives output current determined based on a dimming signal, from a lighting device, consumes, as consumption current, part of the output current, and supplies supply current to a light-emitting element. The control circuit includes a regulator circuit that regulates the consumption current. The regulator circuit monotonously increases a magnitude of the consumption current relative to a magnitude of the output current.

In order to achieve the above object, a lighting apparatus according to one aspect of the present disclosure includes the control circuit and the lighting device.

In order to achieve the above object, a luminaire according to one aspect of the present disclosure includes the control circuit and the light-emitting element.

In order to achieve the above object, a signboard according to one aspect of the present disclosure includes the luminaire and a display board that is illuminated by the light-emitting element and displays at least one of a character and a graphic.

In order to achieve the above object, a control method for use in a control circuit according to one aspect of the present disclosure is a control method for use in a control circuit that receives output current determined based on a dimming signal, from a lighting device, consumes, as consumption current, part of the output current, and supplies supply current to a light-emitting element. The control method includes regulating the consumption current. In the regulating, a magnitude of the consumption current is monotonously increased relative to a magnitude of the output current.

The present disclosure is capable of providing, for example, a control circuit that receives output current determined based on a dimming signal, supplies supply current to a light-emitting element, and is capable of bringing a dimming curve close to a desired dimming curve.

### BRIEF DESCRIPTION OF DRAWINGS

The figures depict one or more implementations in accordance with the present teaching, by way of examples only, not by way of limitations. In the figures, like reference numerals refer to the same or similar elements. FIG. 1 is a circuit block diagram illustrating usage of a control circuit and a lighting apparatus according to Embodiment 1;

FIG. 2 is a graph illustrating an overview of a waveform of supply current outputted from a modulation circuit according to Embodiment 1;

FIG. 3 is a circuit diagram illustrating an example of a circuit configuration of the modulation circuit according to Embodiment 1;

FIG. 4 is a block diagram illustrating a configuration of the lighting device according to Embodiment 1;

FIG. 5 is a circuit diagram illustrating a circuit configuration of a modulation circuit in a comparative example;

FIG. 6 is a graph illustrating a relationship between average current and a dimming signal in the comparative example;

FIG. 7 is a graph illustrating a dimming curve when the modulation circuit in the comparative example is used;

FIG. 8 is a graph illustrating an example of a relationship between average current and a dimming signal according to Embodiment 1;

FIG. 9 is a graph illustrating an example of a dimming curve when the modulation circuit according to Embodiment 1 is used;

FIG. 10 is a graph illustrating another example of the relationship between the average current and the dimming signal according to Embodiment 1;

FIG. 11 is a graph illustrating a dimming curve when the modulation circuit according to Embodiment 1 is used;

FIG. 12 is a flow chart illustrating a procedure of a control method for use in the modulation circuit according to Embodiment 1;

FIG. 13 is a circuit block diagram illustrating usage of a control circuit and a lighting apparatus according to Embodiment 2;

FIG. 14 is a circuit diagram illustrating an example of a circuit configuration of a modulation circuit according to Embodiment 2;

FIG. 15 is a flow chart illustrating a procedure of a control method for use in the modulation circuit according to Embodiment 2;

FIG. 16 is an external view of a luminaire according to an application example of Embodiment 3; and

FIG. 17 is an external view of a signboard according to an application example of Embodiment 3.

### DETAILED DESCRIPTION OF THE EMBODIMENTS

Hereinafter, embodiments of the present disclosure will be described with reference to the drawings. It should be noted that each of the embodiments described below shows a specific example of the present disclosure. Numerical values, shapes, materials, structural components, the arrangement and connection of the structural components, operation timing, etc. shown in the following embodiments are mere examples, and are not intended to limit the scope of the present disclosure. Moreover, among the structural components in the following embodiments, structural components not recited in any one of the independent claims that indicate the broadest concepts of the present disclosure are described as optional structural components. Furthermore, the figures are schematic diagrams and are not necessarily precise illustrations. In the figures, substantially identical components are assigned the same reference signs, and overlapping description is omitted or simplified.

### Embodiment 1

First, the following describes a control circuit etc. according to Embodiment 1.

### [1-1. Entire Configuration]

A configuration of the control circuit etc. according to Embodiment 1 will be described with reference to drawings.

FIG. 1 is a circuit block diagram illustrating usage of the control circuit and lighting apparatus 40 according to Embodiment 1. As shown in FIG. 1, lighting apparatus 40 according to Embodiment 1 includes lighting device 10 and modulation circuit 20. Modulation circuit 20 is an example of the control circuit according to Embodiment 1. FIG. 1 further shows power source 60, dimmer 62, and light-emitting element 30. Hereinafter, each of the structural components shown in FIG. 1 will be described.

### [1-1-1. Power Source]

Power source 60 supplies power to lighting device 10. For example, Power source 60 is a system power source such as a commercial AC power source.

### [1-1-2. Dimmer]

Dimmer 62 is a signal source that outputs a dimming signal to lighting device 10. Dimmer 62 outputs, for example, a dimming signal that is a square wave voltage signal such as a pulse-width modulation (PWM) signal. A dimming ratio of light-emitting element 30 is regulated based on the dimming signal outputted from dimmer 62. Dimmer 62 includes, for example, a dimming actuator. The dimming actuator is, for example, a rotary actuator or sliding actuator. Dimmer 62 outputs a PWM signal having a duty cycle proportional to an operation amount such as a rotation amount or sliding amount of the actuator.

### [1-1-3. Light-Emitting Element]

Light-emitting element 30 is a light source that is supplied with part of output current I₁ outputted from lighting device 10, and emits visible light. For example, an LED that emits white light is used as light-emitting element 30. It should be noted that light-emitting element 30 is not limited to the LED, and may be an organic electroluminescent (EL) element.

### [1-1-4. Modulation Circuit]

Modulation circuit 20 is an example of a control circuit that receives output current from lighting device 10, consumes, as consumption current, part of the output current, and supplies supply current to light-emitting element 30. Modulation circuit 20 is a circuit that generates supply current i₂ by modulating output current I₁, and outputs supply current i₂ to light-emitting element 30. Modulation circuit 20 generates supply current i₂ by modulating output current I₁ according to a visible light communication signal. To drive modulation circuit 20, output current I₁ outputted from lighting device 10 is used. In other words, modulation circuit 20 consumes part of output current I₁ outputted from lighting device 10. Current consumed by modulation circuit 20 is referred to as consumption current I_{M}.

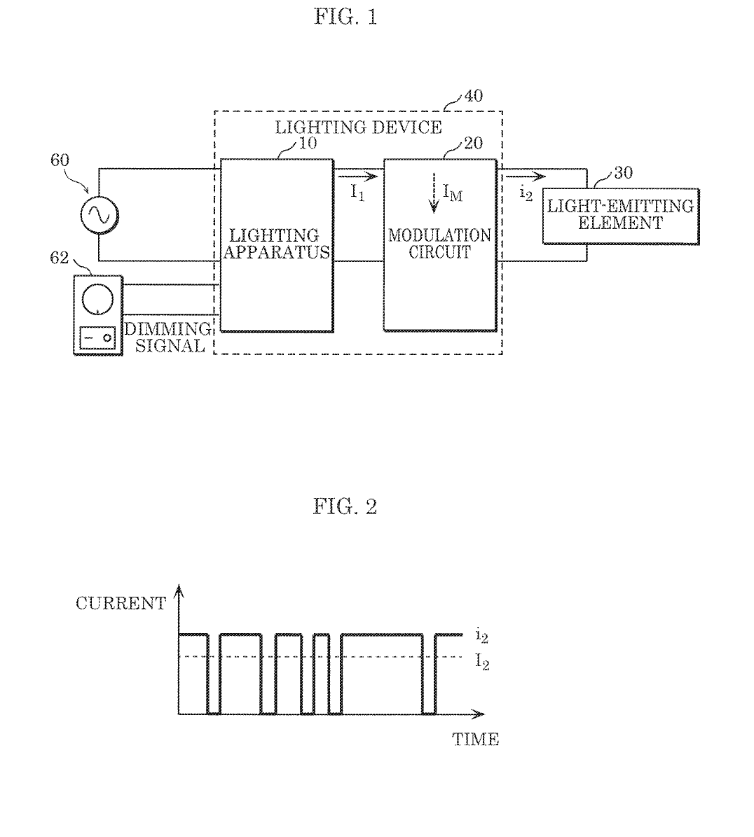

Here, supply current i₂ outputted from modulation circuit 20 is described with reference to the drawings. FIG. 2 is a graph illustrating an overview of a waveform of supply current i₂ outputted from modulation circuit 20 according to Embodiment 1. In FIG. 2, the solid line indicates supply current i₂, and the broken line indicates current I₂ which represents the average of supply current i₂.

Supply current i₂ shown in FIG. 2 is supplied to light-emitting element 30. As a result, the intensity of light emitted from light-emitting element 30 is modulated in the same manner as supply current i₂. Visible light communication can be performed using the intensity of the light thus modulated. Since a modulation period of supply current i₂ is set to be so sufficiently short that human eyes cannot detect the modulation period, human eyes perceive that light-emitting element 30 is emitting light having a constant intensity corresponding to average current I₂.

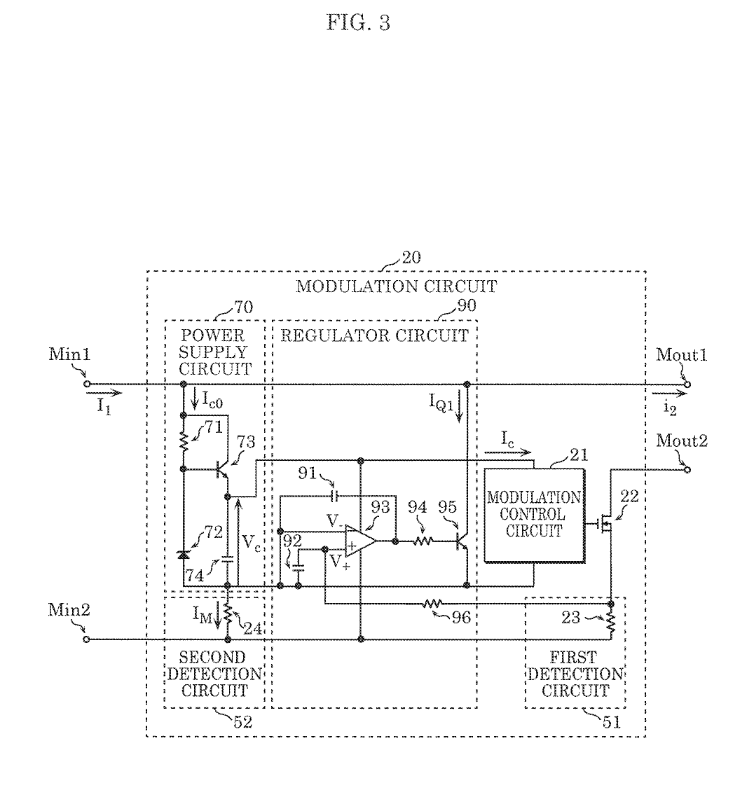

The following describes a circuit configuration of modulation circuit 20 with reference to the drawings. FIG. 3 is a circuit diagram illustrating an example of the circuit configuration of modulation circuit 20 according to Embodiment 1. As shown in FIG. 3, modulation circuit 20 according to

Embodiment 1 receives output current I₁ from lighting device 10 via input terminals Min1 and Min2, and supplies supply current i₂ to light-emitting element 30 via output terminals Mout1 and Mout2. Modulation circuit 20 includes power supply circuit 70, regulator circuit 90, modulation control circuit 21, first detection circuit 51, second detection circuit 52, and switch element 22.

Power supply circuit 70 is a circuit that generates constant voltage Vₑ to be used by regulator circuit 90 and modulation control circuit 21, using current I_{c0} that is part of output current I₁ outputted from lighting device 10. Power supply circuit 70 includes resistor 71, Zener diode 72, transistor 73, and capacitor 74.

In Embodiment 1, a bipolar transistor is used as transistor 73. As shown in FIG. 3, Zener diode 72 has the cathode terminal connected to the base terminal of transistor 73. Power supply circuit 70 is capable of generating certain voltage V_{c} by appropriately setting the Zener voltage of Zener diode 72 and the base-emitter voltage of transistor 73.

Capacitor 74 is a smoothing capacitor that stabilizes voltage V_{c}, and is connected between the anode terminal of Zener diode 72 and the emitter terminal of transistor 73.

First detection circuit 51 is a circuit that detects supply current i₂. First detection circuit 51 includes resistor 23 and outputs, as first detection value V₊, voltage applied to resistor 23.

Second detection circuit 52 is a circuit that detects consumption current I_{M}. Second detection circuit 52 includes resistor 24 and outputs, as second detection value V₋, voltage applied to resistor 24.

Regulator circuit 90 is a circuit that regulates consumption current I_{M} to be consumed by modulation circuit 20. In Embodiment 1, regulator circuit 90 includes: error amplifier 93 that amplifies a difference between first detection value V₊ detected by first detection circuit 51 and second detection value V₋ detected by second detection circuit 52; and current control element 95 that regulates consumption current I_{M} according to an output of error amplifier 93. Regulator circuit 90 further includes capacitors 91 and 92 and resistors 94 and 96. In Embodiment 1, a bipolar transistor is used as current control element 95.

Current control element 95 regulates a magnitude of current I_{Q1} flowing through current control element 95, based on output voltage from error amplifier 93. Current I_{Q1} flows through second detection circuit 52 and becomes part of consumption current I_{M}. Accordingly, consumption current I_{M} can be regulated by regulating current I_{Q1}. Where resistance values of resistors 23 and 24 in modulation circuit 20 according to Embodiment 1 are expressed as R₂₃ and R₂₄, respectively, following Equation 1 holds.

I₂×R₂₃=I_{M}×R₂₄ (Equation 1)

In consequence, it is possible to cause consumption current I_{M} to be proportional to average current I₂. Moreover, following Equation 2 holds.

I₁=I₂+I_{M}=(R₂₄/R₂₃+1)×I_{M} (Equation 2)

In consequence, it is possible to cause consumption current I_{M} to be proportional to output current I₁.

Capacitor 91 is a phase compensating capacitor of error amplifier 93. Capacitor 92 is a smoothing capacitor that stabilizes voltage outputted from first detection circuit 51.

Modulation control circuit 21 is a circuit that modulates output current I₁ outputted from lighting device 10. Modulation control circuit 21 includes a microcomputer etc., and voltage V_{c} generated by power supply circuit 70 and current I_{c} are applied to modulation control circuit 21. Modulation control circuit 21 is, for example, an large-scale integration (LSI) including a read-only memory (ROM) that stores a program, a random-access memory (RAM) as a transient memory region, a processor that executes a program, an input output circuit such as an A/D converter and a D/A converter, a counter and timer, etc. Modulation control circuit 21 functions as part of modulation circuit 20. Specifically, modulation control circuit 21 outputs a drive signal for turning on and off switch element 22 based on a visible light communication signal, according to a built-in program. The visible light communication signal is, for example, data indicating a fixed character string determined by a built-in program, a dynamically variable character string, or identification (ID) of a lighting apparatus. It should be noted that the visible light communication signal may be inputted from the outside.

Switch element 22 is an element for modulating output current I₁. In Embodiment 1, switch element 22 modulates output current I₁ by switching a conduction state and a non-conduction state between output terminal Mout2 and input terminal Min2 of modulation circuit 20. As a result, modulated supply current i₂ is generated.

### [1-1-5. Lighting Device]

Lighting device 10 is a device that outputs output current I₁ determined based on a dimming signal. As shown in FIG. 1, lighting device 10 is connected to modulation circuit 20. The following describes lighting device 10 in detail with reference to the drawings.

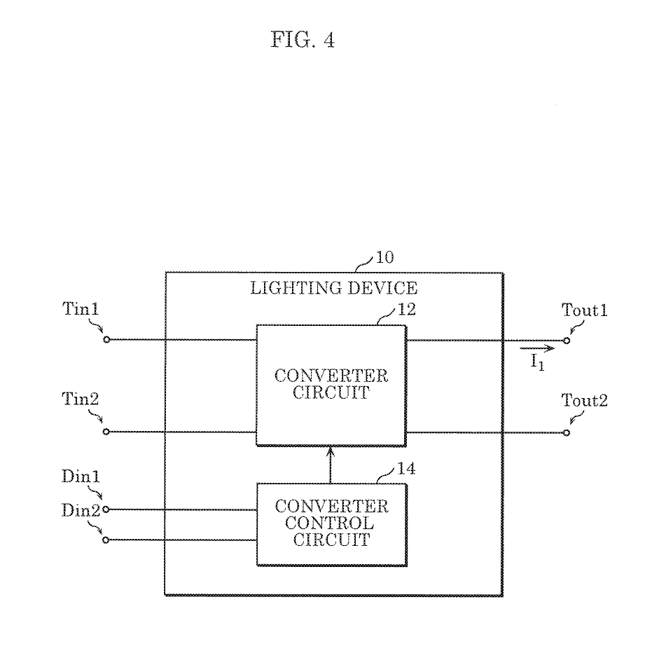

FIG. 4 is a block diagram illustrating a configuration of lighting device 10 according to Embodiment 1. As shown in FIG. 4, lighting device 10 mainly includes converter circuit 12 and converter control circuit 14.

Converter circuit 12 is a circuit that generates output current I₁. In Embodiment ₁, converter circuit 12 converts AC current that power source 60 inputted to input terminals Tin1 and Tin2, into DC output current I₁, and outputs DC output current I₁ through output terminals Tout1 and Tout2. Converter circuit 12 is not particularly limited as long as converter circuit 12 is a circuit that converts current supplied from power source 60 into output current. Converter circuit 12 is achieved by, for example, combining an AC/DC converter and a DC/DC converter.

Converter control circuit 14 is a circuit that controls converter circuit 12 based on a dimming signal inputted from dimmer 62. Converter control circuit 14 is implemented by, for example, a microcomputer that generates a signal corresponding to a dimming signal. Dimmer 62 inputs a dimming signal to converter control circuit 14 via dimming signal input terminals Din1 and Din2. Converter circuit 12 is caused to output output current I₁ corresponding to the dimming signal, according to a signal outputted from converter control circuit 14. The signal outputted from converter control circuit 14 is inputted to, for example, a switch element (not shown) for regulating output current I₁ to be outputted from converter circuit 12.

Converter control circuit 14 causes a relationship between the dimming signal and output current I₁ to correspond to a desired dimming curve, by controlling converter circuit 12. Here, a dimming curve is a curve indicating a relationship between a dimming signal and a dimming ratio of light-emitting element 30. A desired dimming curve is a dimming curve predefined by a manufacturer of lighting device 10, a user, etc. For example, the desired dimming curve may be a dimming curve defined in such a manner that the lowest dimming level is 1%.

### [1-2. Operation]

The following describes the operation of lighting device 10 and modulation circuit 20 according to Embodiment 1.

### [1-2-1. Comparative Example]

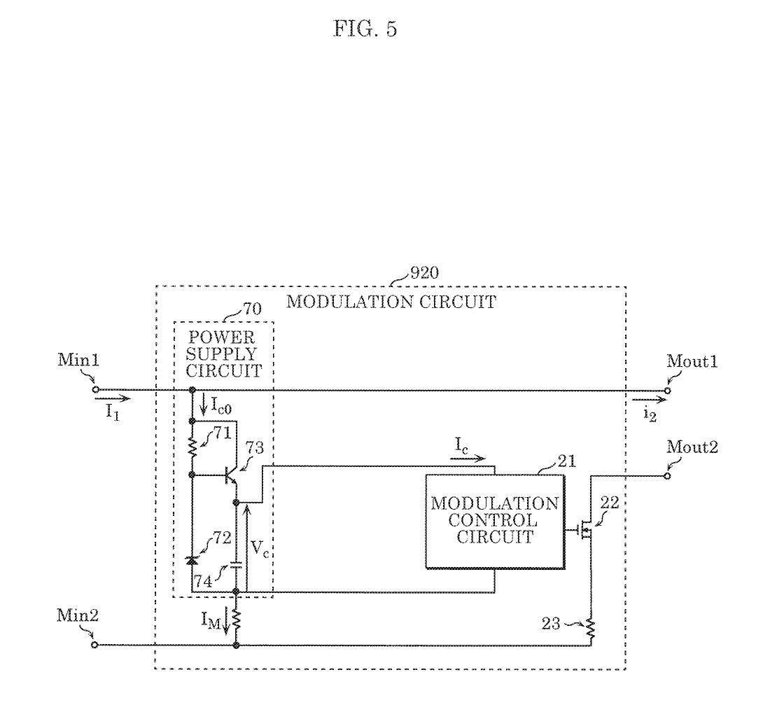

First, in order to explain advantageous effects of modulation circuit 20 according to Embodiment 1, operation when a modulation circuit in a comparative example is used will be described with reference to the drawings. FIG. 5 is a circuit diagram illustrating a circuit configuration of modulation circuit 920 in the comparative example. As shown in FIG. 5, a case is examined in which a circuit obtained by removing regulator circuit 90 from modulation circuit 20 according to Embodiment 1 is used as modulation circuit 920 in the comparative example.

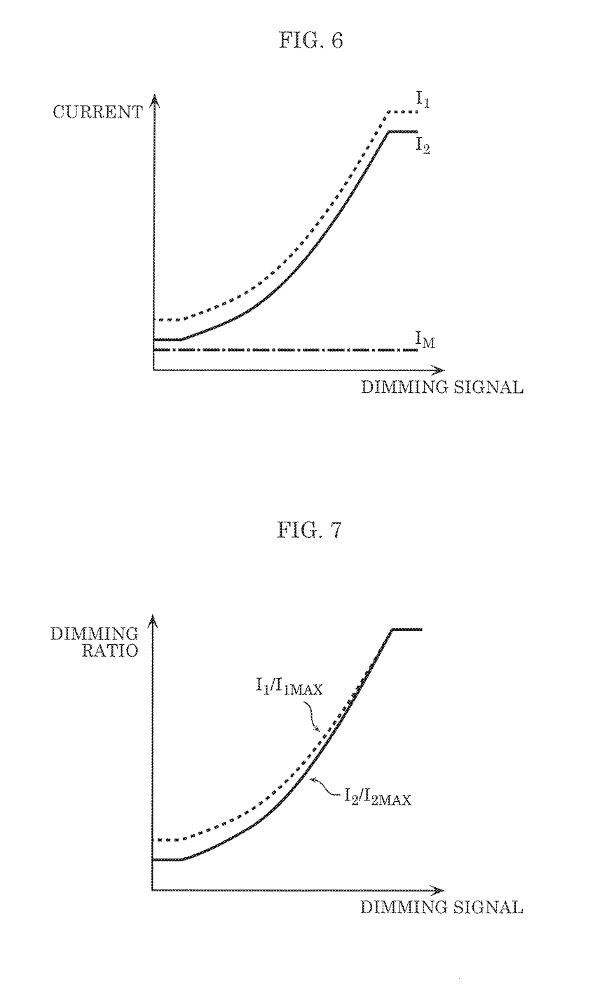

FIG. 6 is a graph illustrating a relationship between average current I₂ and a dimming signal in the comparative example. FIG. 6 also shows output current I₁ from lighting device 10 (refer to the broken line in the graph of FIG. 6) and consumption current I_{M} consumed by modulation circuit 920 (refer to the alternate long and short dash line in the graph of FIG. 6) in the comparative example. FIG. 7 is a graph illustrating a dimming curve when modulation circuit 920 in the comparative example is used. FIG. 7 also shows a relationship between output current I₁/I_{1MAX} and the dimming signal (refer to the broken line in the graph of FIG. 7). Moreover, the horizontal axis shown in each of FIG. 6 and FIG. 7 indicates, for example, a duty cycle of the dimming signal. It should be noted that the broken line indicating the relationship between output current I/I_{1MAX} and the dimming signal is a dimming curve when light-emitting element 30 is connected in series with lighting device 10, that is, when modulation circuit 20 is not connected, and corresponds to a desired dimming curve.

As shown in FIG. 6, modulation circuit 920 in the comparative example consumes an approximately certain amount of consumption current I_{M} without depending on the dimming signal. For this reason, average current I₂ obtained by subtracting a certain amount of consumption current I_{M} from output current I₁ is supplied to light-emitting element 30. Consequently, as shown by the graph of FIG. 7, when modulation circuit 920 in the comparative example is used, a difference increases between the dimming curve (the solid line in the graph of FIG. 7) and the desired dimming curve (the broken line in the graph of FIG. 7). In particular, when a dimming level is low, the difference becomes prominent.

### [1-2-2. Operation Example 1]

Next, the following describes an operation example when modulation circuit 20 according to Embodiment 1 is used, with reference to the drawings.

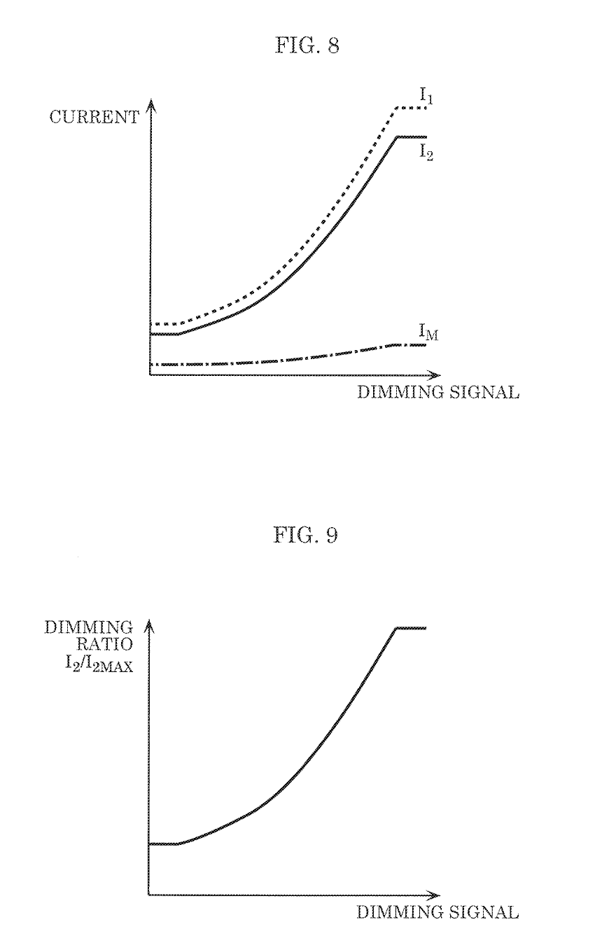

FIG. 8 is a graph illustrating an example of a relationship between average current I₂ and a dimming signal according to Embodiment 1. FIG. 8 also shows output current I₁ from lighting device 10 (refer to the broken line in the graph of FIG. 8) and consumption current I_{M} consumed by modulation circuit 20 (refer to the alternate long and short dash line in the graph of FIG. 8). FIG. 9 is a graph illustrating an example of a dimming curve when modulation circuit 20 according to Embodiment 1 is used.

As shown in FIG. 8, regulator circuit 90 of modulation circuit 20 monotonously increases a magnitude of consumption current I_{M} relative to a magnitude of output current I₁. In other words, the magnitude of consumption current I_{M} and the magnitude of output current I₁ have a positive correlation. In the operation example, regulator circuit 90 causes the magnitude of consumption current I_{M} to be proportional to the magnitude of output current I₁. Accordingly, it is possible to cause a magnitude of average current I₂ equivalent to a value obtained by subtracting the magnitude of consumption current I_{M} from the magnitude of output current I₁ to be proportional to the magnitude of output current I₁. It should be noted that the expression “cause . . . to be proportional to” is not limited to causing something completely proportional to something else, and includes a case in which a slight margin of error exists. For example, the expression includes a case in which at most approximately 5% error exists.

As described above, by causing average current I₂ of supply current i₂ outputted from modulation circuit 20 to be proportional to output current I₁, as shown in FIG. 9, it is possible to allow the dimming curve to have the same shape as the curve of output current I₁/I_{1MAX}. Here, since the curve of output current I₁/I_{1MAX} is identical to the desired dimming curve, it is possible to achieve the desired dimming curve in Embodiment 1.

### [1-2-3. Operation Example 2]

In the preceding section, the operation example is described assuming that consumption current I_{M} calculated by Equation 1 is greater than current I_{c0} consumed by power supply circuit 70 and modulation control circuit 21 of modulation circuit 20. The following describes an operation example in the case where consumption current I_{M} calculated by Equation 1 is less than current I_{c0} in a range in which a dimming level is low, and consumption current I_{M} calculated by Equation 1 is greater than current I_{c0} in a range in which the dimming level is high, with reference to the drawings.

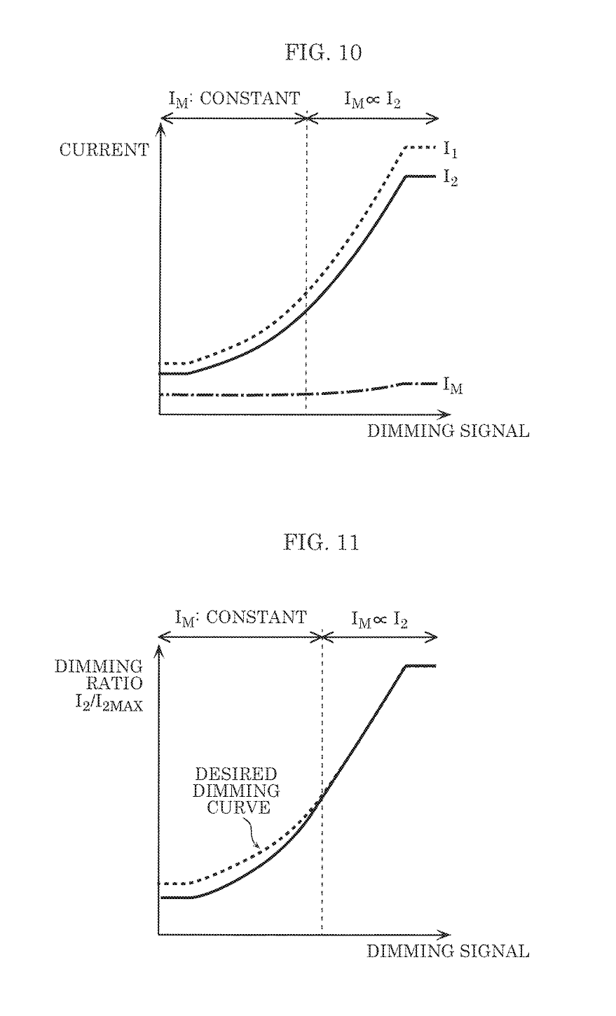

FIG. 10 is a graph illustrating another example of the relationship between average current I₂ and the dimming signal according to Embodiment 1. FIG. 10 also shows output current I₂ from lighting device 10 (refer to the broken line in the graph of FIG. 10) and consumption current I_{M} consumed by modulation circuit 20 (refer to the alternate long and short dash line in the graph of FIG. 10). FIG. 11 is a graph illustrating a dimming curve when modulation circuit 20 according to Embodiment 1 is used.

As stated above, when consumption current I_{M} calculated by Equation 1 is less than current I_{c0}, a voltage inputted to an inverting input terminal of error amplifier 93 is higher than a voltage inputted to a non-inverting input terminal of the same. For this reason, an output voltage of error amplifier 93 is zero, and current control element 95 to which the output voltage is inputted is put in a non-conduction state. Accordingly, when consumption current I_{M} calculated by Equation 1 is less than consumption current I_{c0}, current I_{M} equals I_{c0} and is approximately constant without depending on the dimming signal.

In contrast, in the range in which the dimming level is high, consumption current I_{M} calculated by Equation 1 is greater than current I_{c0}, and, as with the example described with reference to FIG. 8 and FIG. 9, consumption current I_{M} is proportional to average current I₂ and output current I₁.

As described above, in the operation example, as shown in FIG. 11, in a range in which the dimming level is low and consumption current I_{M} is constant, there is a difference between a desired dimming curve (the broken line in the graph of FIG. 11) and an actual dimming curve (the solid line in the graph of FIG. 11). In contrast, in a range in which the dimming level is high and consumption current I_{M} is proportional to average current I₂, a desired dimming curve is achieved. In this manner, the operation example makes it possible to achieve a dimming curve closer to the desired dimming curve than the dimming curve of the comparative example.

### [1-3. Control Method]

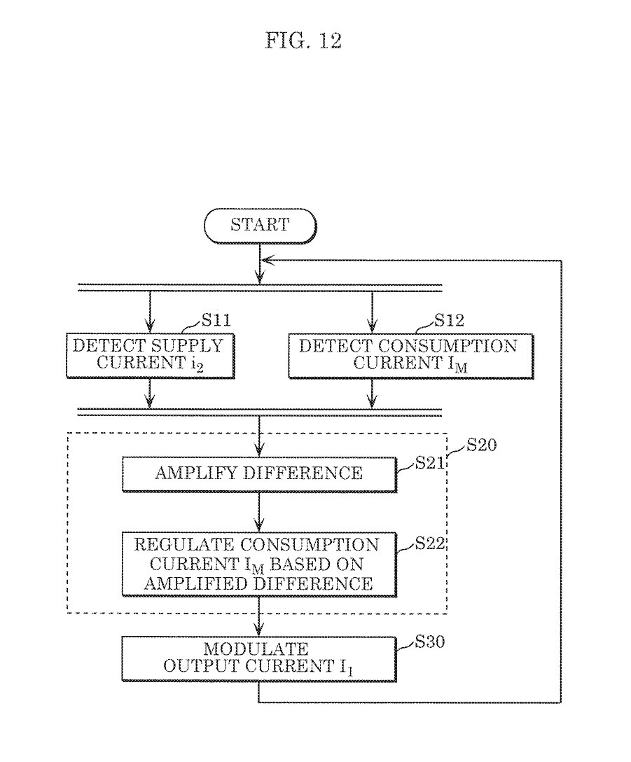

Next, the following describes a control method for use in modulation circuit 20 with reference to the drawings. FIG. 12 is a flow chart illustrating a procedure of the control method for use in modulation circuit 20 according to Embodiment 1.

As shown in FIG. 12, in Embodiment 1, first, first detection circuit 51 detects supply current i₂ (S11), and second detection circuit 52 detects consumption current I_{M} (S12).

Next, regulator circuit 90 regulates consumption current I_{M} (S20). More specifically, first, error amplifier 93 amplifies a difference between a first detection value detected by first detection circuit 51 and a second detection value detected by second detection circuit 52 (S21). Subsequently, regulator circuit 90 regulates consumption current I_{M} according to the difference amplified by error amplifier 93 (S22). In Embodiment 1, a magnitude of consumption current I_{M} is caused to be proportional to a magnitude of output current I₁.

Next, in Embodiment 1, modulation control circuit 21 modulates output current I₁ according to a visible light communication signal (S30).

The control method for use in modulation circuit 20 according to Embodiment 1 repeats the above steps.

With such a control method, it is possible to bring a dimming curve close to a desired dimming curve by regulating consumption current I_{M} in modulation circuit 20.

### [1-4. Summary]

As described above, modulation circuit 20, the example of the control circuit according to the embodiment, is a circuit that receives output current I₁ determined based on a dimming signal, from lighting device 10, consumes, as consumption current I_{M}, part of output current I₁ supplies supply current i₂ to light-emitting element 30. Modulation circuit 20 includes regulator circuit 90 that regulates consumption current I_{M}. Regulator circuit 90 monotonously increases a magnitude of consumption current I_{M} relative to a magnitude of output current I₁.

By causing modulation circuit 20 to monotonously increase consumption current I_{M} relative to output current I₁, it is possible to bring a dimming curve close to a desired dimming curve compared to a case in which consumption current I_{M} is approximately constant without depending on a dimming signal.

Moreover, modulation circuit 20 may further include modulation control circuit 21 that modulates output current I₁ according to a visible light communication signal.

With this, since the intensity of light emitted from light-emitting element 30 can be modulated according to the visible light communication signal, using light-emitting element 30 that emits visible light enables visible light communication.

Moreover, in modulation circuit 20, regulator circuit 90 may cause the magnitude of consumption current I_{M} to be proportional to the magnitude of output current I₁.

With this, it is possible to achieve a desired dimming curve.

Moreover, modulation circuit 20 may further include: first detection circuit 51 that detects supply current i₂; and second detection circuit 52 that detects consumption current I_{M}. Regulator circuit 90 may include: error amplifier 93 that amplifies a difference between a first detection value detected by first detection circuit 51 and a second detection value detected by second detection circuit 52; and current control element 95 that regulates consumption current I_{M} according to an output of error amplifier 93.

With this, it is possible to cause consumption current I_{M} to be proportional to average current I₂ of supply current i₂. Accordingly, as shown by Equation 2, because consumption current I_{M} can be made proportional to output current I₁, it is possible to achieve a desired dimming curve.

Moreover, lighting apparatus 40 according to Embodiment 1 includes modulation circuit 20 and lighting device 10.

Moreover, a control method for use in modulation circuit 20, the example of the control circuit according to the embodiment, is a control method for use in a circuit that receives output current I₁ determined based on a dimming signal, from lighting device 10, consumes, as consumption current I_{M}, part of output current I₁, and supplies supply current i₂ to light-emitting element 30. The control method for use in modulation circuit 20 includes regulating consumption current I_{M}. In the regulating, a magnitude of consumption current I_{M} is monotonously increased relative to a magnitude of output current I₁.

Moreover, the control method for use in modulation circuit 20, the example of the control circuit according to the embodiment, may further include modulating output current I_{I} according to a visible light communication signal.

Moreover, in the control method for use in modulation circuit 20, the example of the control circuit according to the embodiment, in the regulating, the magnitude of consumption current I_{M} may be caused to be proportional to the magnitude of output current I₁.

Moreover, the control method for use in modulation circuit 20, the example of the control circuit according to the embodiment, may further include detecting supply current i₂; and detecting consumption current I_{M}. The regulating may include: amplifying a difference between a first detection value detected in the detecting of supply current i₂ and a second detection value detected in the detecting of consumption current I_{M}; and regulating consumption current I_{M} according to the difference amplified in the amplifying.

### Embodiment 2

Next, the following describes a control circuit and a lighting apparatus according to Embodiment 2. The control circuit according to Embodiment 2 has a more simplified configuration than the control circuit according to Embodiment 1. Hereinafter, a description of the control circuit and the lighting apparatus according to Embodiment 2 will be centered on differences from the control circuit and the lighting apparatus according to Embodiment 1.

### [2-1. Entire Configuration]

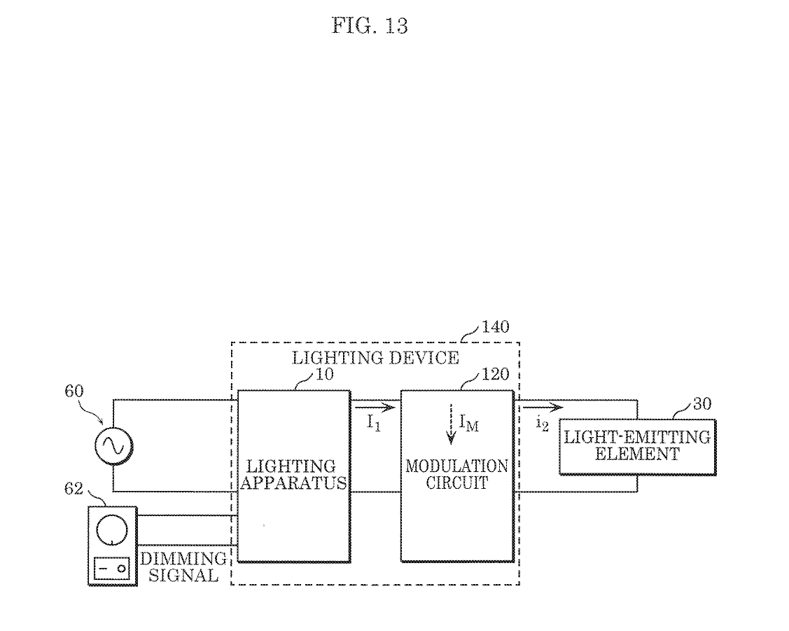

First, a configuration of the control circuit and the lighting apparatus according to Embodiment 2 will be described with reference to drawings. FIG. 13 is a circuit block diagram illustrating usage of the control circuit and lighting apparatus 140 according to Embodiment 2.

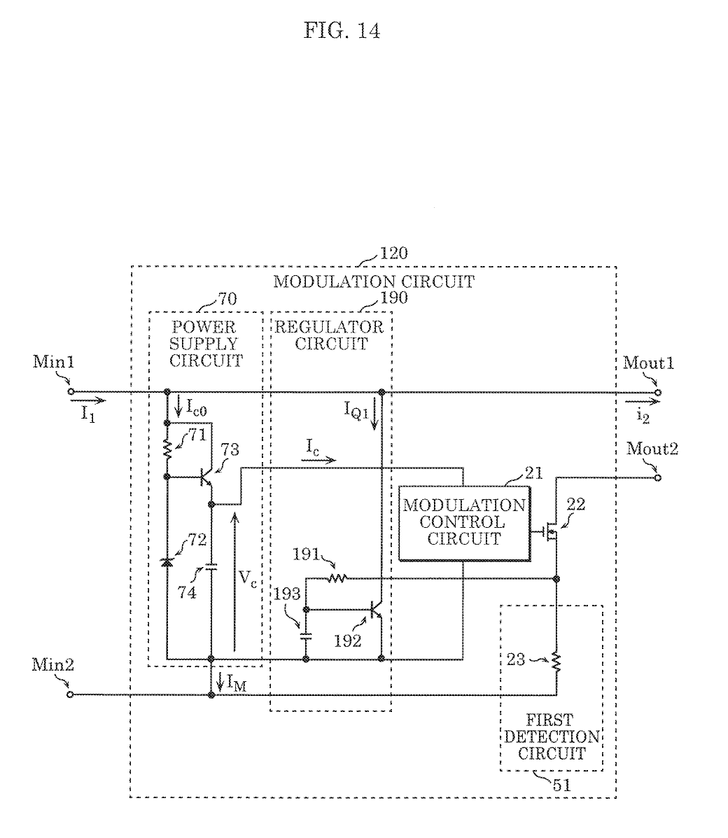

As shown in FIG. 13, lighting apparatus 140 according to Embodiment 2 includes lighting device 10 and modulation circuit 120. Modulation circuit 120 is an example of the control circuit according to Embodiment 2. Lighting apparatus 140 according to Embodiment 2 differs from lighting apparatus 40 according to Embodiment 1 in a configuration of modulation circuit 120. The following describes a circuit configuration of modulation circuit 120 according to Embodiment 2, with reference to the drawings. FIG. 14 is a circuit diagram illustrating an example of the circuit configuration of modulation circuit 120 according to Embodiment 2.

As shown in FIG. 14, like modulation circuit 20 according to Embodiment 1, modulation circuit 120 according to Embodiment 2 receives output current I₁ from lighting device 10 via input terminals Min1 and Min2, and supplies supply current i₂ to light-emitting element 30 via output terminals Mout1 and Mout2. Modulation circuit 120 includes power supply circuit 70, regulator circuit 190, modulation control circuit 21, first detection circuit 51, and switch element 22. Modulation circuit 120 differs from modulation circuit 20 according to Embodiment 1 in not including second detection circuit 52 and a configuration of regulator circuit 190.

Like regulator circuit 90 according to Embodiment 1, regulator circuit 190 is a circuit that regulates consumption current I_{M} to be consumed by modulation circuit 120, and monotonously increases a magnitude of consumption current I_{M} relative to a magnitude of output current I₁. Regulator circuit 190 includes current control element 192, resistor 191, and capacitor 193. Capacitor 193 is a capacitor that smoothes voltage outputted from first detection circuit 51. Current control element 192 is an element that regulates consumption current I_{M} according to a first detection value detected by first detection circuit 51. In Embodiment 2, a bipolar transistor is used as current control element 192. In Embodiment 2, the first detection value detected by first detection circuit 51 is directly inputted to a base terminal of current control element 192. The first detection value corresponds to a product of resistance value R₂₃ and average current I₂ resulting from temporally averaging supply current i₂. For this reason, in Embodiment 2, resistance value R₂₃ of resistor 23 included in first detection circuit 51 is set to cause the first detection value to be greater than or equal to a base-emitter voltage of current control element 192.

### [2-2. Operation]

Next, the following describes the operation of modulation circuit 120 according to Embodiment 2. Since modulation circuit 120 has the above-described circuit configuration, when direct current amplification factor h_{FE} of current control element 192, base-emitter voltage V_{BE}, and resistor value R₁₉₁of resistor 191 are used, current I_{Q1} flowing through regulator circuit 190 is expressed by Equation 3 indicated below.

I_{Q1}=h_{FE}×(R₂₃I₂−V_{BE})/R₁₉₁ (Equation 3)

As above, since current I_{Q1} is substantially proportional to average current I₂, like modulation circuit 20 according to Embodiment 1, modulation circuit 120 according to Embodiment 2 makes it possible to bring a dimming curve close to a desired dimming curve. In addition, it is possible to simplify the circuit configuration of modulation circuit 120 in Embodiment 2. Accordingly, it is possible to reduce the weight, mounting area, and costs of modulation circuit 120.

### [2-3. Control Method]

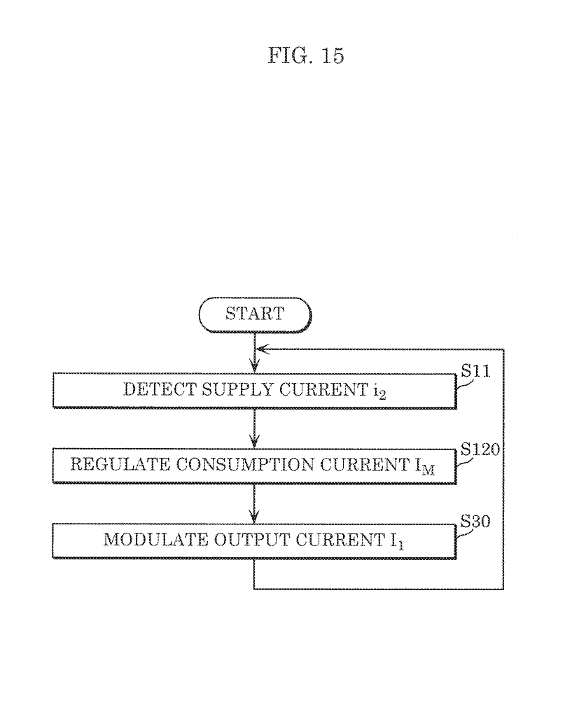

Next, the following describes a control method for use in modulation circuit 120 with reference to the drawings. FIG. 15 is a flow chart illustrating a procedure of the control method for use in modulation circuit 120 according to Embodiment 2.

As shown in FIG. 15, in Embodiment 2, first, first detection circuit 51 detects supply current i₂ (S11).

Next, regulator circuit 190 regulates consumption current I_{M} (S120). In Embodiment 2, regulator circuit 190 regulates consumption current I_{M} according to a first detection value detected by first detection circuit 51. Next, like Embodiment 1, in Embodiment 2, modulation control circuit 21 modulates output current I₁ according to a visible light communication signal (S30).

The control method for use in modulation circuit 120 according to Embodiment 2 repeats the above steps.

With such a control method, it is possible to bring a dimming curve close to a desired dimming curve by regulating consumption current I_{M} in modulation circuit 120.

### [2-4. Summary]

As described above, modulation circuit 120, the example of the control circuit according to Embodiment 2, includes first detection circuit 51 that detects supply current i₂. Regulator circuit 190 includes current control element that regulates consumption current I_{M} according to a first detection value detected by first detection circuit 51.

With this, it is possible to simplify the circuit configuration of modulation circuit 120. Accordingly, it is possible to reduce the weight, mounting area, and costs of modulation circuit 120.

Moreover, a control method for use in modulation circuit 120, the example of the control circuit according to Embodiment 2, may further include detecting supply current i₂. In the regulating, consumption current I_{M} may be regulated according to a first detection value detected in the detecting.

### Embodiment 3

Next, the following describes, as Embodiment 3, application examples of lighting apparatuses 40 and 140 according to Embodiments 1 and 2.

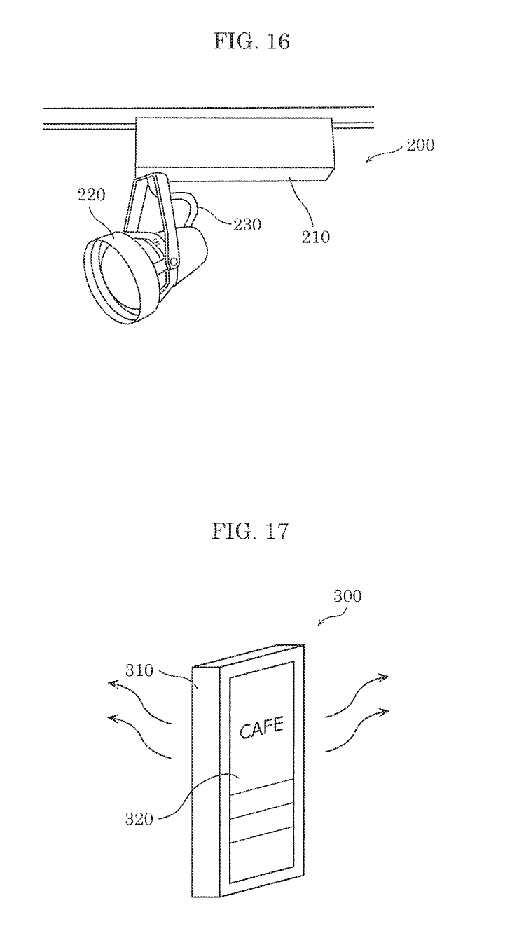

FIG. 16 is an external view of luminaire 200 according to an application example of Embodiment 3. Luminaire 200 is a spotlight installed in the ceiling, wall, pillar, etc. of a room, and includes circuit box 210, lamp body 220, and wire 230. Circuit box 210 is a box that houses lighting apparatus 40 according to Embodiment 1 or lighting apparatus 140 according to Embodiment 2. Lamp body 220 contains an LED as light-emitting element 30. Wire 230 is an example of a load wire that electrically connects circuit box 210 and the LED contained in lamp body 220.

Since such luminaire 200 includes lighting apparatus 40 according to Embodiment 1 or lighting apparatus 140 according to Embodiment 2, luminaire 200 simultaneously performs illumination and visible light communication. In addition, luminaire 200 makes it possible to achieve a desired dimming curve.

It should be noted that although FIG. 16 shows the spotlight as luminaire 200, a luminaire according to an application example of lighting apparatus 40 or 140 is not limited to the spotlight. Examples of the luminaire include a chandelier, a ceiling light, a small lamp, a Japanese lamp, a bracket light, a footlight, a pendant light, a base light, a downlight, a kitchen light, a bathroom light, and an exterior light.

FIG. 17 is an external view of signboard 300 according to an application example of Embodiment 3. Signboard 300 includes: case 310 that houses an LED (not shown) as light-emitting element 30 and lighting apparatus 40 according to Embodiment 1 or lighting apparatus 140 according to Embodiment 2 (not shown) that supplies current to the LED; and display board 320. Display board 320 is a display board that is illuminated from behind by the LED and displays at least one of a character and a graphic, and is, for example, a semi-transparent resin board on which a character is inscribed.

Since such signboard 300 includes lighting apparatus 40 according to Embodiment 1 or lighting apparatus 140 according to Embodiment 2, signboard 300 simultaneously performs display of a character etc. on display board 320 and visible light communication. In the visible light communication, for example, at least one of data indicating a character displayed on display board 320, data indicating identification (ID) of signboard 300, and data indicating a location of signboard 300 is superimposed on illumination light and transmitted. Such signboard 300 makes it possible to achieve a desired dimming curve.

It should be noted that although the LED as light-emitting element 30 and sign board 320 are separate in signboard 300 of FIG. 17, the LED and sign board 320 may be integrally formed. LEDs may be disposed in case 310, and at least one of a character and a graphic may be displayed by the LEDs as a sign board by controlling emission light colors of the LEDs. (Variations etc.)

Although the control circuit, lighting apparatus, luminaire, and signboard according to the present disclosure are described above based on Embodiments 1 to 3, the present disclosure is not limited to Embodiments 1 to 3. Forms obtained by various modifications to Embodiments 1 to 3 that can be conceived by a person skilled in the art as well as forms realized by combining part of the structural components in Embodiments 1 to 3 which are within the scope of the present disclosure are included in the present disclosure.

For example, the configuration in which modulation circuit 20 or 120 is used as the control circuit is described in each of Embodiments 1 to 3, the control circuit is not limited to modulation circuit 20 or 120. The control circuit is not particularly limited as long as the control circuit is a circuit that receives output current determined based on a dimming signal, from a lighting device, consumes, as consumption current, part of the output current, and supplies supply current to light-emitting element 30.

Moreover, although the configuration in which transistor 73 and Zener diode 72 are used as power supply circuit 70 is described in each of Embodiments 1 to 3, power supply circuit 70 is not limited to this configuration. Power supply circuit 70 is not particularly limited as long as power supply circuit 70 is a circuit capable of applying constant voltage V_{c} to modulation control circuit 21. Power supply circuit 70 may be, for example, a low-voltage element such as a three-terminal regulator.

Furthermore, each of the capacitors respectively used in Embodiments 1 to 3 need not be an element, and may be a capacitance component such as a floating capacitance component.

Moreover, each of the resistors respectively used in Embodiments 1 to 3 may be a resistance element or a resistance component included in an electric wire.

Furthermore, although the PWM signal is used as the dimming signal in each of Embodiments 1 to 3, the dimming signal is not limited to this. For example, a dimming signal based on a dimming control mode such as phase control, 1-10V, and digital addressable lighting interface (DALI) may be used.

Moreover, although the bipolar transistors are used as current control elements 95 and 192 in each of Embodiments 1 to 3, current control elements 95 and 192 are not limited to the bipolar transistors. Each of current control elements 95 and 192 may be an element capable of regulating consumption current I_{M} according to voltage inputted to a base terminal thereof.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A control circuit that receives output current determined based on a dimming signal, from a lighting device, consumes, as consumption current, part of the output current, and supplies supply current to a light-emitting element, the control circuit comprising:
a regulator circuit that regulates the consumption current,
wherein the regulator circuit monotonously increases a magnitude of the consumption current relative to a magnitude of the output current.

2. The control circuit according to claim 1, further comprising:
a modulation control circuit that modulates the output current according to a visible light communication signal.

3. The control circuit according to claim 1,
wherein the regulator circuit causes the magnitude of the consumption current to be proportional to the magnitude of the output current.

4. The control circuit according to claim 1, further comprising:
a first detection circuit that detects the supply current; and
a second detection circuit that detects the consumption current,
wherein the regulator circuit includes:
an error amplifier that amplifies a difference between a first detection value detected by the first detection circuit and a second detection value detected by the second detection circuit; and
a current control element that regulates the consumption current according to an output of the error amplifier.

5. The control circuit according to claim 1, further comprising:
a first detection circuit that detects the supply current,
wherein the regulator circuit includes a current control element that regulates the consumption current according to a first detection value detected by the first detection circuit.

6. A lighting apparatus, comprising:
the control circuit according to claim 1; and
the lighting device.

7. A luminaire, comprising:
the control circuit according to claim 1; and
the light-emitting element.

8. The luminaire according to claim 7, further comprising:
the lighting device.

9. A signboard, comprising:
the luminaire according to claim 7; and
a display board that is illuminated by the light-emitting element and displays at least one of a character and a graphic.

10. A control method for use in a control circuit that receives output current determined based on a dimming signal, from a lighting device, consumes, as consumption current, part of the output current, and supplies supply current to a light-emitting element, the control method comprising:
regulating the consumption current,
wherein in the regulating, a magnitude of the consumption current is monotonously increased relative to a magnitude of the output current.

11. The control method according to claim 10, further comprising:
modulating the output current according to a visible light communication signal.

12. The control method according to claim 10,
wherein in the regulating, the magnitude of the consumption current is caused to be proportional to the magnitude of the output current.

13. The control method according to claim 10, further comprising:
detecting the supply current; and
detecting the consumption current,
wherein the regulating includes:
amplifying a difference between a first detection value detected in the detecting of the supply current and a second detection value detected in the detecting of the consumption current; and
regulating the consumption current according to the difference amplified in the amplifying.

14. The control method according to claim 10, further comprising:
detecting the supply current,
wherein in the regulating, the consumption current is regulated according to a first detection value detected in the detecting.
